(19) United States
(12) Patent Application Publication
(10) Pub. No.: US 2005/0038855 A1
(43) Pub. Date: Feb. 17, 2005

(54) Systems and methods for collecting data regarding a messaging session

(76) Inventors: Terry M. Martin, Ft. Collins, CO (US); Jay D. Knitter, Wellington, CO (US); Blaine R. Southam, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/630,071

(22) Filed: Jul. 30, 2003

(51) Int. Cl. G06F 15/16; G06F 15/173

(52) U.S. Cl. 709/206; 709/223

(57) ABSTRACT

Disclosed are systems and methods for collecting data regarding a messaging session. In one embodiment, a system and a method pertain to intercepting an incoming message, writing session information to a thread-local variable, and providing the incoming message to an associated system component.

### BACKGROUND

Network services, such as “web” services, are network-based applications that operate in a distributed computing environment to perform specific tasks in response to client requests. Currently, most such web services are focused on providing a variety of real world services, or information about such services, across the Internet.

To cite an example, a given web service may be designed to identify the cheapest long distance rates for a given client. In such a case, the client may provide various information to the web service such as a client identity, a city and state of residence, an indication of typical calling patterns, etc., and the web service will use that information to identify a service provider and/or calling plan that would cost the least for the client based upon the client-provided information. In making the determination as to which service provider and/or calling plan is best for the client, the web service may leverage the resources of one or more other web services, for instance hosted by one or more long distance service providers (e.g., AT&T™, Sprint™, MCI™, etc.). Specifically, the web service that was called upon by the client to return the best provider/plan may act in the capacity of a client relative to other web services in order to collect information from those services that is needed to make the provider/plan determination.

FIG. 1 depicts such a messaging session, i.e. a series or chain of messages pertinent to a given initial request. As indicated in that figure, a system 100 comprises a client, a network service A, and a network service B. As indicated in FIG. 1, the client sends a request (1) to network service A, which in turn sends a related request (2) to network service B. In the latter communication, the network service A acts in the capacity of a client in relation to network service B, which may be considered to be a supporting network service. Next, network service B determines what information to provide in reply to the request and transmits a response (3) to network service A. Network service A then determines how to respond to the client and sends a response (4) to the client to complete the messaging session.

To ensure that a developed network service, such as network service A, as well as the network services it interacts with (e.g., network service B), is operating correctly it is desirable to collect data regarding communications that occur between network services. For instance, collecting information regarding the time at which a request was sent from one network service to another network service, as well as information as to the substance of the request, may be useful for purposes of profiling system operation, debugging service delivery problems, and identifying transmission and/or processing bottlenecks.

Such information is typically collected by modifying the code of one or more of the network services to record this information. For instance, custom logging code may be integrated into a network service for the purpose of logging the information. Such insertion is highly invasive and normally requires substantial investment in terms of time and money for the development of the logging code and its integration into the network service. Moreover, even when a developer is willing to make such an investment, the developer may not have access to the network service code in the first place.

In theory, an external data collection mechanism that intercepts all incoming and outgoing messages to a system component (client and/or network service) could be used to collect data on behalf of the system component. In such a case, the underlying code of the component would not need to be modified. However, such a solution has its own problems. One such problem is how to propagate information within the system so that information can be obtained as to the entire messaging session. Another problem is correlating all information that pertains to a given session when concurrent sessions, and their associated messages, are processed by the system at the same time. These problems can be best explained with an example.

Assume, in the system of FIG. 1, that an operator of network service A wishes to collect data regarding the processing time spent by the network service B in processing a request that service A sent to service B. Although an external data collection mechanism could be used to log when the request was sent from point “a” to network service B, as well as the time when a response was received from network service B at point “d,” without knowing what time the request was received at point “b” or what time the response was sent at point “c,” the actual time that network service B spent processing the request will not be known to the operator.

Although the response could, optionally, be instrumented by an external mechanism of network service B to contain information as to when the response was sent (i.e. from point “c”), the processing time will still be unknown without knowledge of the time that was expended in transmitting the request to network service B. Using currently available solutions, the response from network service B cannot be instrumented to convey the time at which the request was received unless the underlying code of the network service B is written, or modified, to do so. As identified above, such an invasive solution is undesirable. Moreover, even when all desired information is collected, the information that pertains to any given session will not be distinguishable from the information that pertains to other sessions unless correlating information, such as a session identifier, is recorded along with each piece of collected information. For instance, a given system component (e.g., service) may collect information as to multiple received messages, but without being correlated to a given session, it will not be possible to determine to which session each piece of information pertains. Therefore, a picture of the entire session, from initial request to final response, will not be obtainable.

### SUMMARY

Disclosed are systems and methods for collecting data regarding a messaging session. In one embodiment, a system and a method pertain to intercepting an incoming message, writing session information to a thread-local variable, and providing the incoming message to an associated system component.

### BRIEF DESCRIPTION OF THE DRAWINGS

The disclosed systems and methods can be better understood with reference to the following drawings. The components in the drawings are not necessarily to scale.

FIG. 1 is a schematic view of a prior art system in which a client makes requests of a network service.

FIG. 2 is a schematic view of a system in which messaging session information is propagated for purposes of data collection.

FIG. 3 is a block diagram of an embodiment of a computing device on which a network service of the system shown in FIG. 2 can execute.

FIGS. 4A-4D provide a flow diagram that illustrates an embodiment of operation of the system shown in FIG. 2.

FIG. 5 is a schematic view of the system of FIG. 2 and depicts the system logging and propagating messaging information.

FIG. 6 is a schematic view of an embodiment of a session timing profile reflective of messaging activity shown in FIG. 5.

FIG. 7 is a flow diagram of an embodiment of operation of a message handler in intercepting and manipulating an incoming message.

FIG. 8 is a flow diagram of an embodiment of operation of a message handler in intercepting and manipulating an outgoing message.

FIG. 9 is a flow diagram that summarizes an embodiment of operation of a message handler.

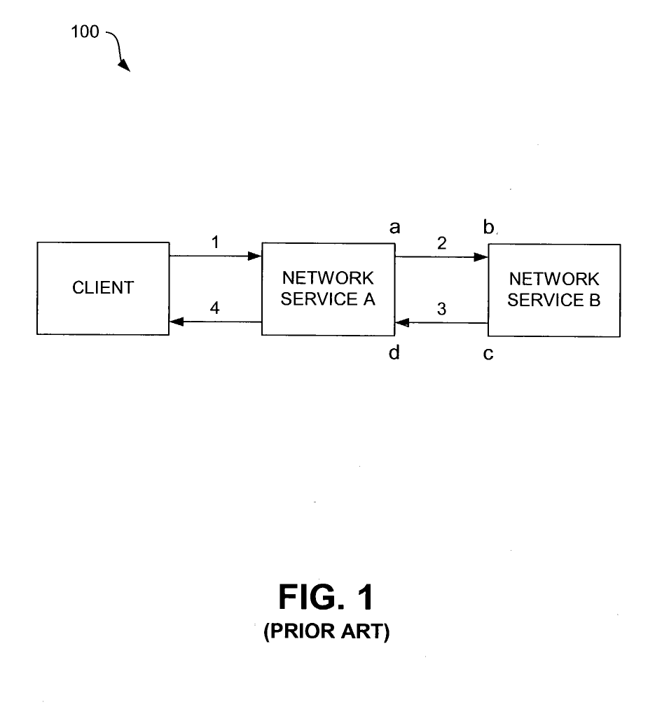

### DETAILED DESCRIPTION

As described above, it is desirable to collect data regarding communications that occur between network services to evaluate how a developed network service, as well as the network services it interacts with, is operating. However, it is further desirable to collect such information in a non-invasive manner that does not require modification of network service code and/or re-deployment of the network service.

As is discussed in the following, information as to network service operation can be collected by storing information about the messages that are sent from and received by a network service using one or more message handlers. To enable the collection of such information, the message handlers can further instrument the messages to propagate session information between network services, as well as facilitate propagation of the session information from a receiving end to a sending end of a network service without modification of the network service code. In addition, correlating information can be collected and propagated along with the session information so that the various pieces of information that pertain to a given messaging session (i.e., series or chain of messages pertinent to an initial request) can be distinguished from other collected information. Therefore, all messaging information pertinent to a given session can be associated together so that system operation as to any session can be profiled and, if desired, the system can be reconfigured to improve performance and/or overcome problems (e.g., bugs, bottlenecks).

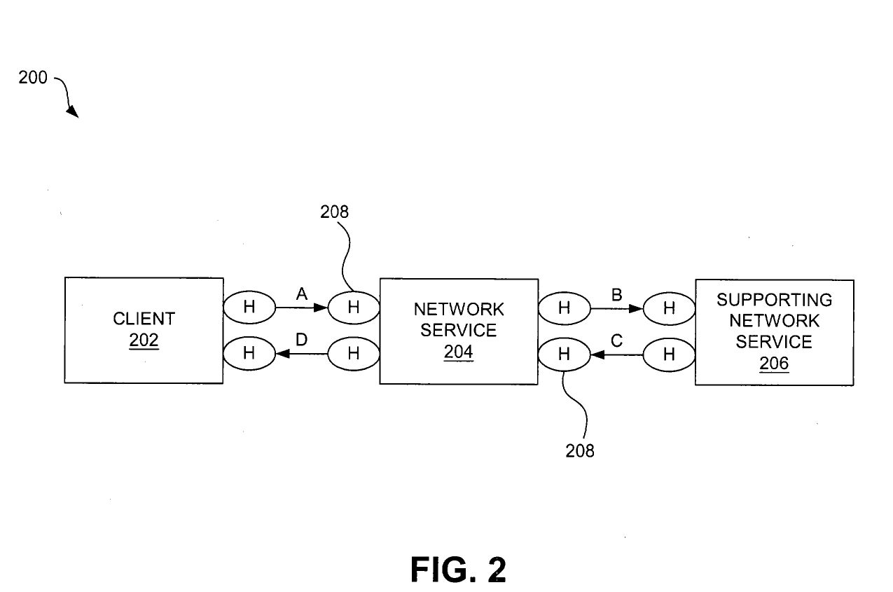

Referring now in more detail to the drawings, in which like numerals indicate corresponding parts throughout the several views, FIG. 2 illustrates an example system 200 in which network services may operate and data regarding this operation may be collected. As indicated in this figure, the system 100 generally comprises a client 202, a network service 204, and a supporting network service 206 that is accessible to the network service 204 via, for example, an external network (not shown), such as the Internet. Although only one client 202, network service 204, and supporting network service 206 are shown, multiple numbers of each may be present in the system 200.

The client 202 is configured to make requests of the network service 204, and may comprise a network browser, such as a web browser that is configured to communicate on the World Wide Web (i.e. the “Web”) via hypertext transfer protocol (HTTP) and hypertext markup language (HTML), and/or an application comprising one or more user interfaces (UIs) that are used to collect information that is to be provided to the network service 204.

The network service 204 is a service that, for instance, is the focus of testing and/or system evaluation for which messaging session information is to be collected. Optionally, the network service 204 may comprise a service that was developed and configured for utilization on the Web and, therefore, may comprise a “web” service. Regardless, the network service 204 is configured to both receive and supply content (i.e. static and/or dynamic content) over a network, such as the Internet. The network service 204 is typically configured to use standard Web protocols such as HTTP, HTML, extensible markup language (XML), and simple object access protocol (SOAP). As is known in the art, SOAP is a remote procedure call (RPC) and document exchange protocol used to request and reply to messages between web services. By way of example, the requests sent by the network service 204 comprise XML messages that are wrapped in SOAP envelopes and transmitted via HTTP.

The core functionality provided by the network service 204 depends upon the particular system implementation. In most embodiments, however, the network service 204 is configured to communicate with other network services to satisfy requests made by the client 202. By way of example, the network service 204 may comprise a service that identifies the least expensive telephone calling plan for the client, locates airline tickets that satisfy client-provided criteria (e.g., departure time, arrival time, cost, etc.), determines the most appropriate form of shipping based upon client requirements (e.g., airmail, next day delivery, etc.), identifies hotels that can accommodate a client itinerary, or the like.

The network service 204 may be configured (i.e. hard-coded) to interact with the supporting network service 206 (as well as other such services). For the purposes of this disclosure, the term “supporting network service” identifies a network (e.g., web) service that has been deployed for use by other network services on a given, normally public, network such as the Internet. By way of example, the supporting network service 206 comprises a web service that is hosted by a third party, such as a party that provides services that the client is seeking (e.g., telephone services, plane ticket reservations, shipping services, hotel accommodations, etc.).

As is further illustrated in FIG. 2, each system component can be provided with at least one message handler 208 that, as is discussed in greater detail below facilitates the collection and propagation of data regarding messaging activity between system components. The message handlers 208 facilitate data collection by intercepting incoming and/or outgoing messages of the system components (client or service). In embodiments in which, as in FIG. 2, a message handler 208 is provided to intercept all messages sent to and from a system component, data may be collected as to each message of any given messaging session. Accordingly, information can be collected regarding an initial request (message A) sent from the client 202 to the network service 204, a related request (message B) sent from the network service 204 to the supporting network service 206, a first response (message C) sent from the supporting network service to the network service 204, and a second response (message D) sent from the network service 204 to the client. When such information is collected, a session profile or “trace” may be generated and, if desired, analyzed to evaluate system performance.

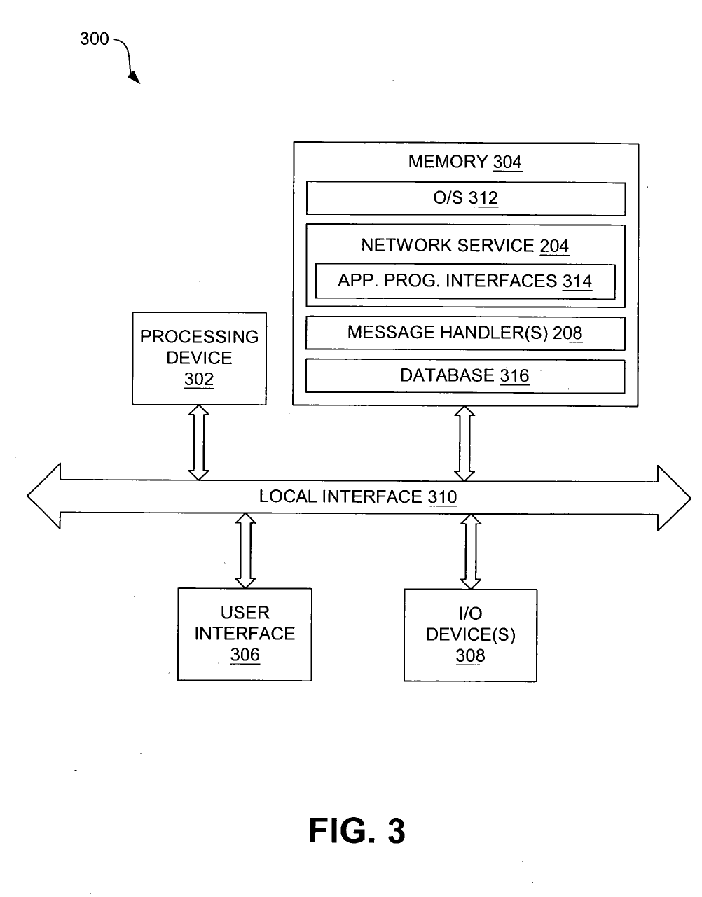

FIG. 3 is a schematic view of an example architecture for a computing device 300 on which the network service 204, as well as its associated message handlers 208, can execute. As indicated in FIG. 3, the computing device 300 comprises a processing device 302, memory 304, a user interface 306, and one or more input/output (I/O) devices 308, each of which is connected to a local interface 310.

The processing device 302 can include a general-purpose processor, a microprocessor, one or more application-specific integrated circuits (ASICs), a plurality of suitably configured digital logic gates, or other electrical configurations comprised of discrete elements that coordinate the overall operation of the computing device 300.

The memory 304 includes any one of a combination of volatile memory elements (e.g., random access memory (RAM)) and nonvolatile memory elements (e.g., hard disk, read only memory (ROM), Flash memory, etc.).

The user interface 306 comprises the components with which a user can interact with the computing device 300. For example, where the computing device 300 comprises a personal computer (PC) or similar computer, these components can comprise, for instance, a keyboard, mouse, and a display.

With further reference to FIG. 3, the one or more I/O devices 308 comprise components that are adapted to facilitate connection of the computing device 300 to another device and may therefore include one or more serial, parallel, small computer system interface (SCSI), universal serial bus (USB), IEEE 1394 (e.g., Firewire™), or other communication components. In addition, the I/O devices 308 comprise the various components used to transmit and/or receive data over a network. By way of example, such components include one or more of a modulator/demodulator (e.g., modem), wireless (e.g., RF) transceiver, and/or a network card.

The memory 304 comprises various programs, in software and/or firmware, including an operating system (O/S) 312 and the network service 204. The O/S 312 controls the execution of other software and provides scheduling, input-output control, file and data management, memory management, and communication control and related services. Optionally, the O/S 312 may incorporate or support a virtual machine, such as a JVM, on which the network service 204 executes.

The network service 204 includes one or more application program interfaces (APIs) 314 that are configured to call at least one message handler 208. As noted above, each message handler 208 is a mechanism that is configured to intercept and process messages independent of the underlying system component code (network service code in this case). In situations in which the messages sent and received by the network service 204 are SOAP messages (e.g., XML messages wrapped in SOAP envelopes), the message handlers 208 comprise SOAP message handlers. The message handlers 208 can be implemented by, for instance, modifying APIs 314 of the network service code to call a message handler each time a message is about to be sent or has been received.

Such modification of the APIs 314 can be made at hook points or ports of the APIs, which are typically integrated into such APIs, particularly in the case of SOAP APIs. Accordingly, instead of rewriting the existing network service code to collect data, the APIs 314 of the code are merely leveraged to implement the message handlers 208 to thereby enable non-invasive data collection. Notably, the underlying network service code need not “know” that this data collection is occurring, and the network service developer need not know anything about a given message handler 208, except how to install and configure it.

Although a single message handler 208 may be implemented to intercept all incoming and outgoing messages for a system component (network service 204 in this case), two or more such handlers can be used, for instance one handler being configured to intercept outgoing messages and another handler being configured to intercept incoming messages. As is described in greater detail below, the message handlers 208 are configured to store data regarding the messaging activity of its associated system component (network service 204 in this case), and further can be used to propagate messaging session information for purposes of linking related message events to a single messaging session. The configuration of the message handlers 208 is particular to the underlying implementation in which it is used. More specifically, the message handlers 208 are written for the platform on which they execute so as to be platform-specific. By way of example, the message handlers 208 can be Java-specific message handlers that are configured for use on a Java platform with a specific SOAP messaging API.

As is further indicated in FIG. 3, the memory 304 may further comprise the database 316. This database 316 can be used to store the collected data on the computing device 300. Although the database 316 is shown as being located on the computing device 300, the database can, alternatively, be located on another computing device (e.g., PC or server) or distributed over several such devices, if desired.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can be used by or in connection with an instruction execution system, apparatus, or device, such as a computer-based system, processor-containing system, or other system that can fetch the instructions from the instruction execution system, apparatus, or device and execute the instructions.

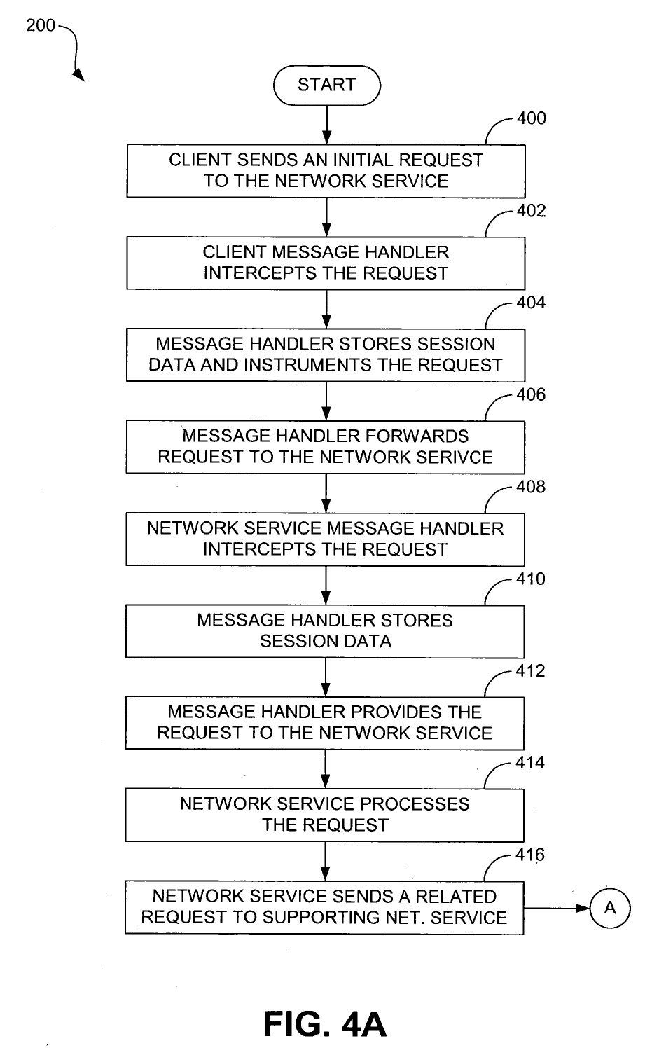

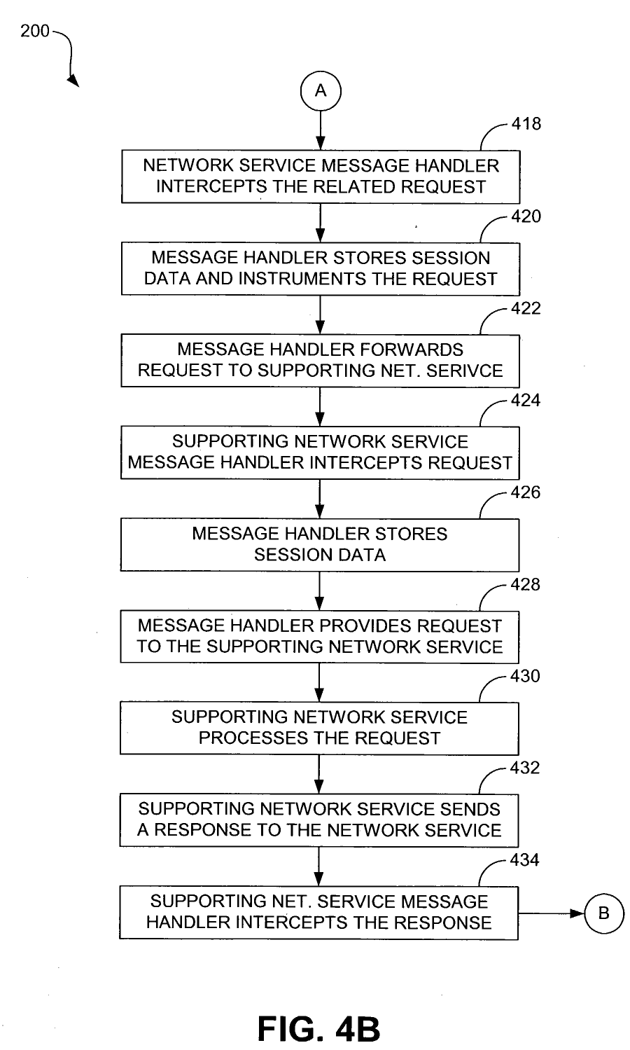

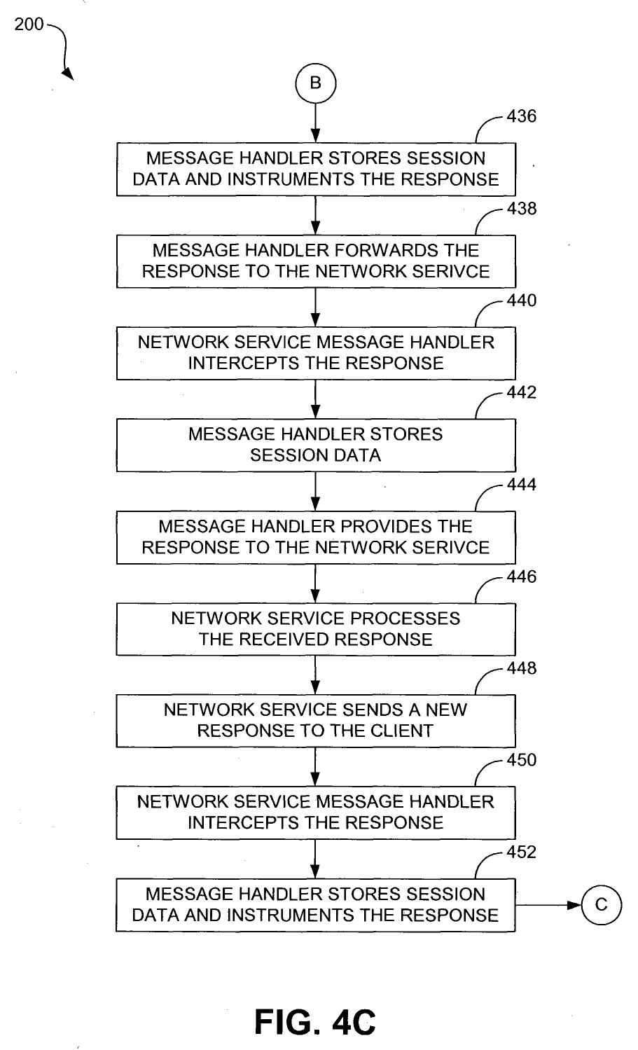

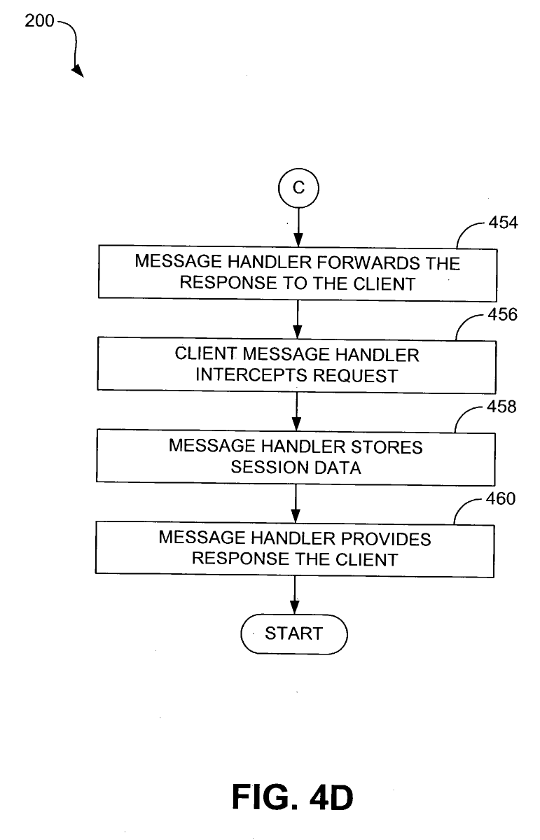

Example systems having been described above, examples of system operation will now be discussed in relation to FIGS. 4A-4D. It is noted that process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

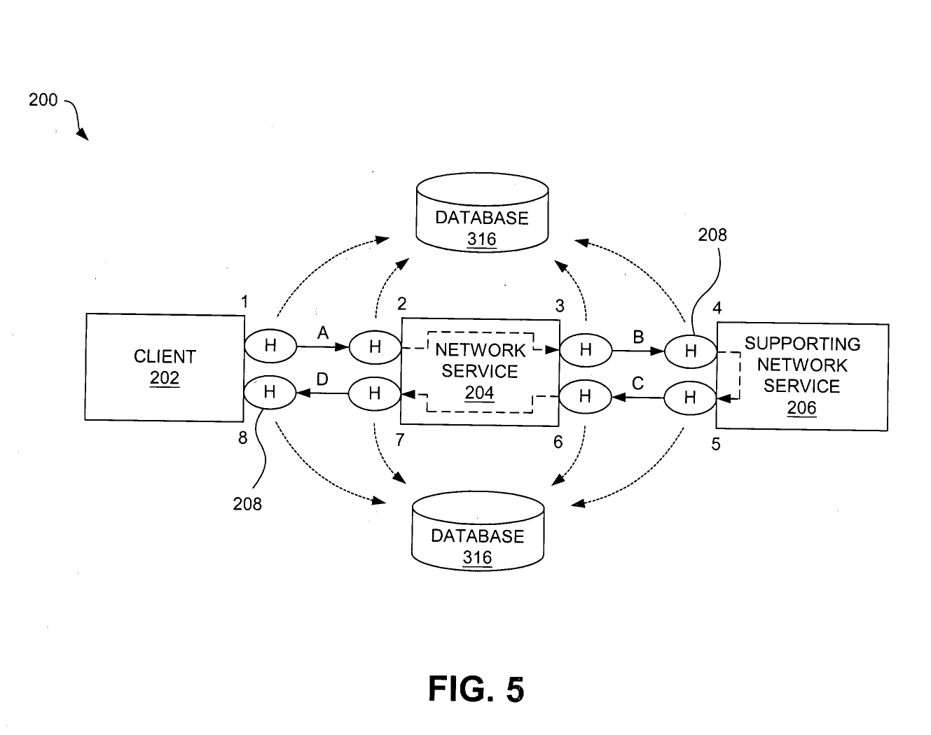

With reference to block 400 of FIG. 4A, the client 202 sends an initial request to the network service 204. For the purposes of this discussion, the network service 204 will be referred to as the “front end” network service to distinguish it from the supporting network service 206. By way of example, the initial request comprises an XML message wrapped in a SOAP envelope. Before the initial request is actually transmitted to the front end network service 204, the client message handler 208 intercepts the request, as indicated in block 402. With reference to the schematic view of FIG. 5, the client message handler intercepts the outgoing request at point 1 shown in the figure.

Because of this interception, the messaging handler 208 of the client 202 can store session data and/or instrument the request, as indicated in block 404. The session data that is stored may vary depending upon the system implementation and the type of information that a user (e.g., a service administrator) would like to collect. By way of example, this information includes one or more of a session identification that identifies the messaging session to which the message (request in this case) pertains, a source name of the sender of the message, a message type (e.g., request or response), a destination name of the intended recipient, and a message sent time (i.e. a timestamp indicating when the request was sent). Optionally, the session information stored by the message handler may further comprise part of or the substance of the message (e.g., XML). The session identification may be generated by the message handler as a result of no such session identified existing (because the message is the first of the session). By way of example, the session identification may comprise a randomly generated number, such as a global unique ID (GUID). As is depicted in FIG. 5, the session information can be stored by the client message handler 208 in the database 316. Depending upon the information that is to be propagated to the next system component (front end network service 204 in this case), similar or the same information can be instrumented into the request before it is forwarded on to the next component. Therefore, session information can be interjected into the request (e.g., into the header of the XML message) including, for instance, one or more of the session identification, the source name, the message type, the destination name, and the message sent time.

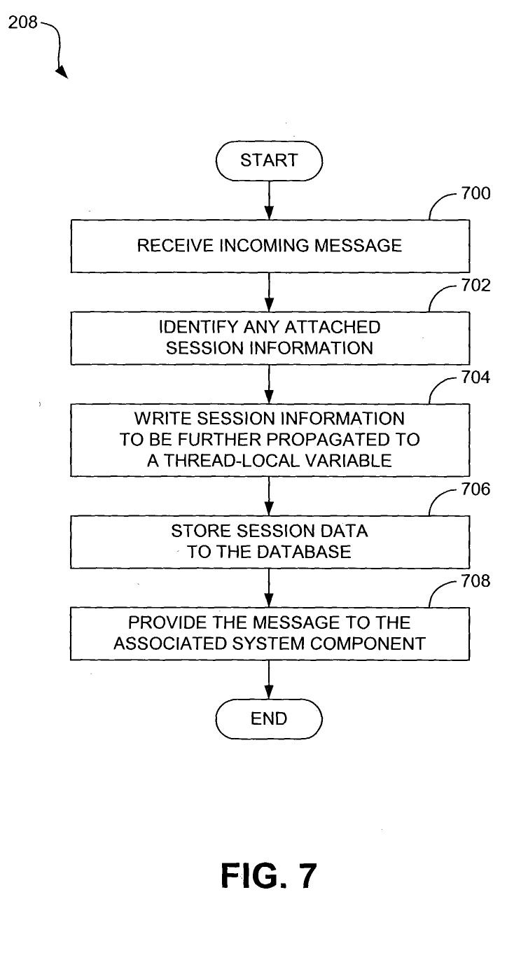

With reference next to block 406 of FIG. 4A, the client message handler 208 then forwards the client request to the front end network service 204. Because of the existence of a message handler 208 of the network service 204, the client request is intercepted, as indicated in block 408. This interception occurs at point 2 in the schematic view of FIG. 5. At this point, the network service message handler 208 can also store session data to the database 316, as indicated in block 410. This data can comprise, for example, all or a portion of the information that was interjected by the client 202 into the request, as well as a message received time (i.e. a timestamp indicating when the request was received). As is described in greater detail with reference to FIG. 7, the network service message handler 208 can further perform certain actions that will ensure propagation of session information to the next system component (the supporting network service 206 in this case). More particularly, the network service message handler 208 can take steps to ensure that a message sent to the supporting network service 206 is instrumented with session information obtained by the message handler 208 that received the client request (at point 2 in FIG. 5).

Once the desired data has been stored by the network service message handler 208, the handler provides the client request to the front end network service 204, as indicated in block 412. At this point, the network service 204 processes the request, as indicated in block 414, so that the network service can determine the appropriate action to take to satisfy the request. In this example, it is presumed that the front end network service 204 will leverage the supporting network service 206 to satisfy the client request. Accordingly, the front end network service 204 sends a related request to the supporting network service 206, as indicated in block 416. The related request may also, for example, comprise an XML message wrapped in a SOAP envelope. Because the front end network service 204 is sending a request to the supporting network service 206, the front end network service may be considered to be a “client” of the supporting network service.

With reference next to block 418 of FIG. 4B, a message handler 208 of the front end network service intercepts the related request before it is actually transmitted to the supporting network service 206. As in the case of the interception performed by the client message handler 208 described in relation to block 404, the network service message handler 208 can store session data and/or instrument the request, as indicated in block 420. Again, the session data that is stored may vary depending upon the system implementation and the type of information that the user wishes to collect. By way of example, this information includes one or more of the source name of the sender of the message, the message type, the destination name, the message sent time, and part of or all of the substance of the message. Moreover, if the session information obtained by the message handler 208 that received the client request was propagated, the session identification and the client request received time can be stored. As is depicted in FIG. 5, this information can be stored by the network service message handler 208 in the database 316 (at point 3). That, or similar, information may also be added to the outgoing related request. For instance, the related request can be instrumented with one or more of the session identification, the source name, the message type, the destination name, the client request received time, and the related request sent time.

With reference next to block 422 of FIG. 4B, the network service message handler 208 then forwards the related request to the supporting network service 206. Because of the provision of a message handler 208 of the supporting network service 206, the related request is intercepted, as indicated in block 424. This interception occurs at point 4 in the schematic view of FIG. 5. At this point, the supporting network service message handler 208 can also store session data to the database 316, as indicated in block 426 including, for instance, all or a portion of the information that was interjected by the front end network service 204 and a message received time (i.e. a timestamp indicating when the related request was received). Again, the message handler 208 can further perform certain actions that will ensure propagation of session data to the next system component (the front end network service 204 in this case).

Once the desired data has been stored by the supporting network service message handler 208, the handler provides the related request to the supporting network service 206, as indicated in block 428. The supporting network service 206 processes the request, as indicated in block 430, so that the supporting network service can determine the appropriate action to take to satisfy the request. After that determination has been made, the supporting network service 206 sends a response to the front end network service 204, as indicated in block 432. Next, with reference to block 434, a message handler 208 of the supporting network service 206 intercepts the response before it is actually transmitted to the front end network service 204.

Once again, the message handler 208 can store session data and/or instrument the request, as indicated in block 436 of FIG. 4C. The session data can include, for example, one or more of the session identification, the related request received time, the source name, the message type, the destination name, the message sent time, and part of or all of the substance of the message. As is depicted in FIG. 5, this information can be stored by the supporting network service message handler 208 in the database 316 (at point 5). The same or similar information may also be added to the outgoing response. For instance, the response can be instrumented with one or more of the session identification, the source name, the message type, the destination name, and the related request received time, and the response sent time.

With reference next to block 438, the supporting network service message handler 208 forwards the response to the front end network service 204, and a messaging handler 208 of the front end network service intercepts the response, as indicated in block 440. This interception occurs at point 6 in the schematic view of FIG. 5. The front end network service message handler 208 that received the response can store session data to the database 316, as indicated in block 442 including, for instance, all or a portion of the information that was interjected by the supporting network service 206 and a message received time (i.e. a timestamp indicating when the response was received). Once more, the message handler 208 can further perform actions that will ensure propagation of session data to the next system component (the client 202 in this case).

With reference next to block 444, the network service message handler 208 provides the received response to the front end network service 204, and the front end network service processes the response, as indicated in block 446. In this case, this processing comprises analyzing the received response and determining what response to provide the client 202, which provided the initial request. After that determination has been made, the front end network service 204 sends a new response to the client 202, as indicated in block 448. That response is intercepted by a message handler 208 of the front end network service 204, as indicated in block 450, at which point the message handler can store session data and/or instrument the request, as indicated in block 452.

The session data can include, for example, one or more of the session identification, the response received time (i.e. time when the response from the supporting network service 206 was received), the source name, the message type, the destination name, the response sent time (i.e. time when the response was sent from the front end network service 204), and part of or all of the substance of the message. As is depicted in FIG. 5, this information can be stored by the message handler 208 in the database 316 (at point 7). The same or similar information may also be added to the outgoing response. For instance, the response can be instrumented with one or more of the session identification, the response received time, the source name, the message type, the destination name, and the response sent time.

With reference next to block 454 of FIG. 4D, the front end network service message handler 208 forwards the new response to the client 202, and a messaging handler 208 of the client intercepts the response, as indicated in block 456. This interception occurs at point 8 in the schematic view of FIG. 5. The client message handler 208 that received the response can store session data to the database 316, as indicated in block 458 including, for instance, all or a portion of the information that was interjected by the front end network service 204 and a message received time (i.e. a timestamp indicating when the response was received). Finally, at block 460, the message handler 208 provides the response to the client 202, thereby completing the flow for the messaging session.

Although useful information can be obtained by only collecting information with a message handler 208 at one location (e.g., at the network service 204), as can be appreciated from the above discussion, more information about system operation can be collected when each component involved in a given messaging session is equipped with one or more message handlers that collect data and/or instrument messages that are transmitted. In such a case, information can be obtained that provides insight as to the interaction of those components for the entire messaging session or “round trip.”

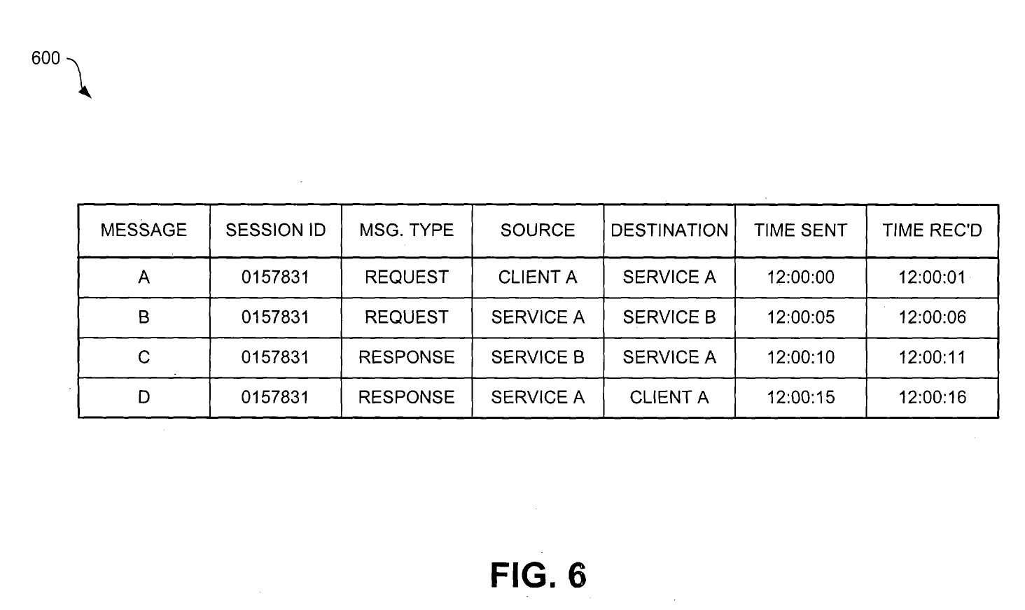

By collecting the above-described session information, a session timing profile can be generated (for instance in the database 316) that contains trace information for all messages pertinent to a given messaging session initiated by the client 202. An example of such a session timing profile 600 is illustrated in FIG. 6. In this example, various messages have been communicated between a client 202 (“client A”), a network service 204 (“service A”), and a supporting network service 206 (“service B”). As is apparent from FIG. 6, a user, for instance a service administrator, can, with reference to the profile 600, identify the sequence of messages sent and received for each session and, therefore, the time that was required to transmit each message (i.e. messages A-D in FIG. 5) as well as the processing time spent by each system component in acting on a received message. From this information, a clear picture of system behavior, network latency, and network service processing time may be gleaned.

In addition to the session trace information, qualitative information regarding a messaging session can be collected. For instance, as described above, the substance of a transmitted request or a received response can be collected by the message handlers 208 and stored in a local database (e.g., in database 318). From this information, system operation can be analyzed to determine if correct responses are being received in response to given requests. Furthermore, it can be determined whether certain actions are taking relatively longer to process as compared to other actions, potentially identifying a software glitch or inefficiency.

Although each message handler 208 in the operational embodiment of FIGS. 4A-4D stores session data (e.g., to the database 316), it is noted that the session data need not be so stored by each message handler. In fact, only one message handler 208, for instance the last message handler implicated in a given messaging session (e.g., the client handler that receives the response sent by the front end network service 204), need store the data if all data that is to be collected has been propagated to that message handler. In such a case, all message handlers 208 upstream of the message handler 208 that will store the session data need only propagate the session information to the storing message handler. Hybrid solutions are also feasible. For example, only message handlers 208 that intercept incoming messages can be configured to store session data. Alternatively, only message handlers 208 that intercept outgoing messages can be configured to store session data. Many variations on these themes are possible.

As noted above, message handlers 208 that receive incoming messages that contain session information, for instance interjected into the message header, may perform certain actions to propagate that information on to the next component in the system. For example, if the network service message handler 208 at point 2 (FIG. 5) receives an instrumented request from the client 202, that network service, as well as the message handler 208 at point 3, may need to act to ensure that the information appended to the request is preserved and added to the related request that is sent to the supporting network service 206.

One way in which session information can be propagated through a system component (e.g., network service) and on to another system component (e.g., supporting network service 206) is to write the session information to a thread-local variable. Once the information is written to the thread-local variable, the message handler 208 that intercepts an outgoing message can use that thread-local variable to obtain the session information and, therefore, instrument the outgoing message with that information such that the information is propagated to another system component.

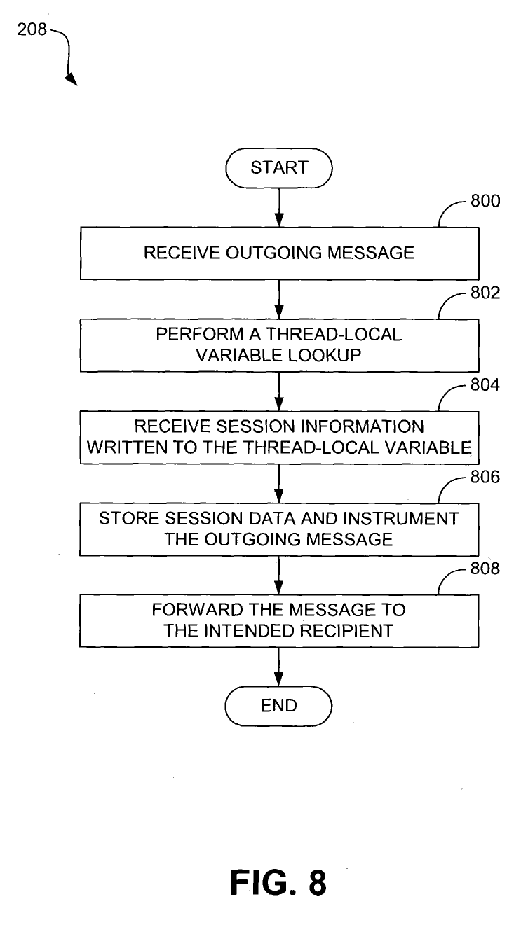

FIGS. 7 and 8 provide examples of operation of a message handler 208 that intercepts incoming messages (e.g., at points 2, 4, and 6) and a message handler 208 that intercepts outgoing messages (e.g., at points 3, 5, and 7), respectively, so that session information can be propagated at least from the receiving end of a system component (e.g., network service) to the sending end of that component.

Beginning with block 700 of FIG. 7, a message handler 208 receives an incoming message. As noted above, the message can comprise a request that was sent by the client 202 or the front end network service 204, or a response that was sent by the supporting network service 206 or the front end service. Regardless, if the message comprises session information that is to be propagated, the message handler 208 identifies the session information that is contained in the message, as indicated in block 702. When information is to be propagated, at least the session identification is identified (and therefore will be propagated) in that this information can be used to identify all of the various pieces of data that are stored in the database 316 as belonging to a particular messaging session. Therefore, for instance, a complete timing profile such as that shown in FIG. 6 can be generated.

With reference next to block 704, the message handler 208 writes the session information to be propagated to a thread-local variable. Thread-local variables are global variables that, although generally available to the system components, only provides information specific to a particular request based upon the thread that was created to handle that request. Accordingly, although multiple threads may be executed by the system component (e.g., network service) at a given time, only specific pieces of data are accessible from the thread-local variable to the various threads. The functionality provided by thread-local variables is available in several computing platforms. By way of example, the Java platform supports what are called “ThreadLocal Variables.” When a Java platform is implemented, the thread-local variables may further comprise inheritable thread-local variables to which data may be written that will be accessible to the thread to which the data originally pertained, as well as all descendant threads that were spawned from the original thread. In such a case, the data written to the thread-local variable will be accessible irrespective of whether new threads are created by a given network service in processing a message (e.g., request).

Once the desired session information has been written to the thread-local variable, the message handler 208 stores any session data that is to be stored in the database 316, as indicated in block 706. Examples of the type of data that is stored are provided in relation to FIGS. 4A-4D. Next, in block 708, the message handler 208 provides the received message to its associated system component for processing.

After the message has been processed by the system component (e.g., network service), a further message may be sent by the component as described in relation to FIGS. 4A-4D. A further (or the same) message handler 208 then intercepts or receives the outgoing message, as indicated in block 800 of FIG. 8. As indicated in block 802, the message handler 208 then performs a thread-local variable lookup to obtain any data that the message handler 208 in FIG. 7 wrote to the thread-local variable. Typically, as noted above, this data at least includes the session identification. In that the message handler 208 is executing on a given thread, the system platform associates that thread with the information that was written to the thread-local variable in association with that thread (or an ancestor of that thread).

The message handler 208 that performed the lookup then receives the session information written to the thread-local variable, as indicated in block 804. At this point, the message handler 208 can store session data and instrument the outgoing message (block 806) in the manner described in relation to FIGS. 4A-4D. Finally then, the message handler 208 forwards the message on to the intended recipient, as indicated in block 808.

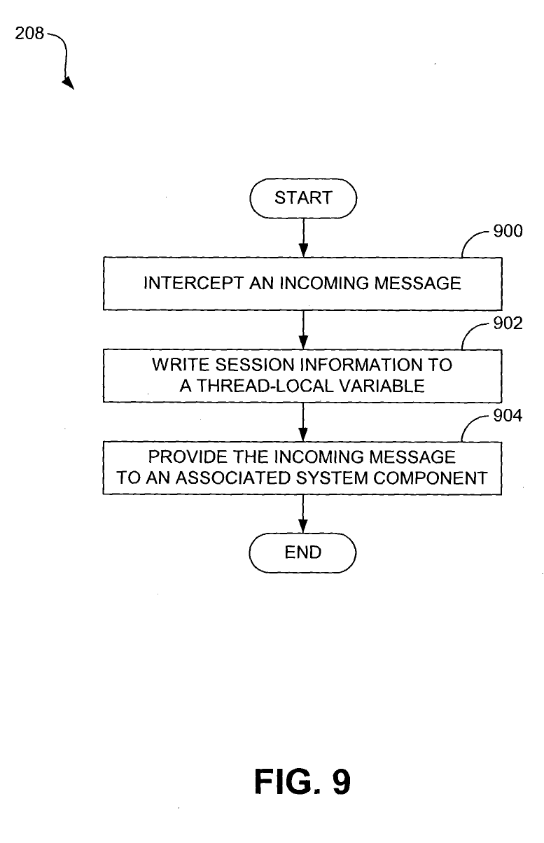

In view of the above disclosure, the operation of a message handler 208 at each system end point can be summarized as indicated in FIG. 9. Beginning with block 900 of that figure, the message handler 208 intercepts an incoming message directed to a system component. Next, the message handler 208 writes session information to a thread-local variable, as indicated in block 902. Finally, the message handler 208 provides the incoming message to its associated system component, as indicated in block 904.

1. A method for collecting data regarding a messaging session, the method comprising:
intercepting an incoming message;
writing session information to a thread-local variable; and
providing the incoming message to an associated system component.

2. The method of claim 1, wherein intercepting an incoming message comprises intercepting an extensible markup language (XML) message wrapped in a simple object access protocol (SOAP) envelope.

3. The method of claim 1, wherein intercepting an incoming message comprises intercepting a service request.

4. The method of claim 1, wherein intercepting an incoming message comprises intercepting a service response.

5. The method of claim 1, wherein writing session information to a thread-local variable comprises writing at least a session identification to the thread-local variable.

6. The method of claim 1, wherein writing session information to a thread-local variable comprises writing at least one of a session identification, a source name of the sender of the message, a message type, a destination name of the intended recipient, and a message received time.

7. The method of claim 1, wherein writing session information to a thread-local variable comprises writing session information to a thread-local variable using a message handler.

8. The method of claim 7, wherein writing session information to a thread-local variable comprises writing session information to a thread-local variable using a simple object access protocol (SOAP) message handler.

9. The method of claim 1, further comprising storing session information in a database.

10. The method of claim 1, further comprising intercepting an outgoing message and performing a thread-local variable lookup so as to receive the session information written to the thread-local variable.

11. The method of claim 10, further comprising storing session data regarding the outgoing message to a database.

12. The method of claim 10, further comprising instrumenting the outgoing message with session information.

13. A system for collecting data regarding a messaging session, the system comprising:
means for intercepting an incoming message;
means for identifying session information attached to the incoming message;
means for writing session information to a thread-local variable; and
means for providing the incoming message to an associated system component.

14. The system of claim 13, wherein the means for writing session information to a thread-local variable comprise means for writing at least a session identification to the thread-local variable.

15. The system of claim 13, wherein the means for writing session information to a thread-local variable comprise a message handler.

16. The system of claim 15, wherein the message handler comprises a simple object access protocol (SOAP) message handler.

17. The system of claim 13, further comprising means for storing session information.

18. The system of claim 13, further comprising means for intercepting an outgoing message and means for performing a thread-local variable lookup.

19. The system of claim 18, further comprising means for storing session data regarding the outgoing message.

20. The system of claim 18, further comprising means for instrumenting the outgoing message with session information.

21. A system for collecting data regarding a messaging session, the system comprising:
logic configured to intercept an incoming message directed at a system component;
logic configured to identify session information attached to the incoming message; and
logic configured to write session information to a thread-local variable.

22. The system of claim 21, wherein the logic configured to write session information to a thread-local variable comprises logic configured to write at least a session identification to the thread-local variable.

23. The system of claim 21, wherein the logic configured to write session information to a thread-local variable comprises a message handler.

24. The system of claim 23, wherein the message handler comprises a simple object access protocol (SOAP) message handler.

25. The system of claim 21, further comprising logic configured to store session information in a database.

26. The system of claim 21, further comprising logic configured to intercept an outgoing message and perform a thread-local variable lookup so as to receive session information written to the thread-local variable.

27. The system of claim 26, further comprising logic configured to instrument the outgoing message with session information.

28. A message handler stored on a computer-readable medium, comprising:
logic configured to intercept an incoming message directed at a system component;
logic configured to identify session information attached to the incoming message;
logic configured to write session information to a thread-local variable; and
logic configured to provide the incoming message to the system component.

29. The message handler of claim 28, wherein the logic configured to write session information to a thread-local variable comprises logic configured to write at least a session identification to the thread-local variable.

30. The message handler of claim 28, further comprising logic configured to store session information in a database.

31. The message handler of claim 28, wherein the message handler comprises a simple object access protocol (SOAP) message handler.

32. A message handler stored on a computer-readable medium, comprising:
logic configured to intercept an outgoing message directed at a system component;
logic configured to perform a thread-local variable lookup to receive session information pertinent to the outgoing message;
logic configured to instrument the outgoing message with session information; and
logic configured to forward the outgoing message to the system component.

33. The message handler of claim 32, wherein the logic configured to instrument the outgoing message comprises logic configured to instrument the outgoing message with at least a session identification.

34. The message handler of claim 32, further comprising logic configured to store session information in a database.

35. The message handler of claim 32, wherein the message handler comprises a simple object access protocol (SOAP) message handler.

36. A network service, comprising:
logic configured to process requests sent from a client;
a first message handler including logic configured to intercept an incoming message directed at the network service and logic configured to write session information to a thread-local variable; and
a second message handler including logic configured to intercept an outgoing message sent by the network service and logic configured to perform a thread-local variable lookup to receive session information pertinent to the outgoing message.
